(19) United States
(12) Patent Application Publication
(10) Pub. No.: US 2026/0169709 A1
(43) Pub. Date: Jun. 18, 2026

(54) Dynamic Application Execution on Client Devices

(71) Applicant: Synamedia Limited, Maidenhead (GB)

(72) Inventors: Michael Joseph Burns, Jerusalem (IL); Yaacov Levy, Maale Adummim (IL)

(21) Appl. No.: 18/981,418

(22) Filed: Dec. 13, 2024

(51) Int. Cl. G06F 8/36; G06F 8/41

(52) U.S. Cl. CPC G06F 8/36; G06F 8/447

(57) ABSTRACT

Techniques for dynamic application packaging and execution are described herein. In various embodiments, one or more servers, which include one or more processors and non-transitory memory, duplicate a component in an application to generate duplicated components within the application. The server(s) then package the application to include diversified versions of the duplicated components and obtaining metadata describing the diversified versions. The server(s) also receive from a client device a request for execution of a version of the application, compose a unique manifest for the client device in response to the request, where the unique manifest identifies the version of the application and a version of the component among the diversified versions. The server(s) then cause execution of the version of the application at the client device, including causing execution of the version of the component at the client device according to the unique manifest.

### TECHNICAL FIELD

The present disclosure relates generally to application deployment and execution and, more specifically, to diversification of application for dynamic execution.

### BACKGROUND

Many rich execution environments run on consumer electronic devices, which provide extensible and versatile operating systems. However, these devices along with the operating systems are vulnerable due to the wide attack surface. Controlling changes across multiple system dimensions in such environments increases uncertainty and complexity for attackers, thus reducing their window of opportunity and raising the costs of their probing and attacking efforts. To increase uncertainty and diversity, some systems utilize different implementations of an application that perform the same function, thus limiting the scope of an attack on a specific implementation. However, many application execution environments do not support the downloading and execution of dynamic code for different implementations. In such environments, it is not possible to modify executable code after installation and/or to allow programs to alter their behavior during execution. Consequently, the distribution of a published application creates a monoculture, where every installation of a specific version of the application on a particular consumer electronic device type and model contains identical program code, rendering the devices vulnerable to attacks.

### BRIEF DESCRIPTION OF THE DRAWINGS

So that the present disclosure can be understood by those of ordinary skill in the art, a more detailed description may be had by reference to aspects of some illustrative embodiments, some of which are shown in the accompanying drawings.

FIG. 1 is a block diagram illustrating an exemplary dynamic application packaging and deployment system, in accordance with some embodiments;

FIGS. 2A-2C are listings of exemplary code implementations and corresponding diversity metadata for dynamic application execution, in accordance with some embodiments;

FIG. 3 is a block diagram illustrating an exemplary compiler toolchain supporting an obfuscating compiler in the exemplary dynamic application packaging and deployment system, in accordance with some embodiments;

FIG. 4 is a block diagram illustrating the deployment of dynamic application, in accordance with some embodiments;

FIG. 5 is a block diagram illustrating dynamic application execution, in accordance with some embodiments;

FIGS. 6A and 6B are flowcharts illustrating a method of dynamic application execution, in accordance with some embodiments; and

FIG. 7 is a block diagram of a computing device for dynamic application execution, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION OF EXAMPLE EMBODIMENTS

Numerous details are described in order to provide a thorough understanding of the example embodiments shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example embodiments described herein.

### Overview

Methods, devices, and systems described herein achieve code diversity for critical components used by an application, within the constraint that the code in every installation of the same application version remains identical. By using source code duplication and an obfuscating compiler, the systems described herein build an application that includes multiple, diverse machine code implementations of critical components. The systems individualize which of these critical components are called in an application instance for execution and provide a mechanism to change which components are invoked over time. The methods are applicable to compiled applications or applications that link native code or bytecode, which use one or more critical components but are distributed and deployed in environments that constrain the download and execution of dynamic code. By providing diversification, it becomes difficult to exploit a hack discovered in one instance across other instances of the application, thus enhancing security.

In accordance with various embodiments, a dynamic application packaging and execution method is performed at one or more servers that include one or more processors and non-transitory memory. The method includes duplicating a component in an application to generate duplicated components within the application. The method further includes packaging the application to include diversified versions of the duplicated components and obtaining metadata describing the diversified versions. The method also includes receiving from a client device a request for execution of a version of the application. The method additionally includes composing a unique manifest for the client device in response to the request, wherein the unique manifest identifies the version of the application and a version of the component among the diversified versions. The method further includes causing execution of the version of the application at the client device, including causing execution of the version of the component at the client device according to the unique manifest.

### Example Embodiments

Code diversity refers to creating different implementations of an application that perform the same function to limit the scope of an attack on a specific implementation. The need for code diversity for an application (also referred to as “dynamic code” or “dynamic application”) running in a rich execution environment (REE) of a consumer electronic device arises as a protection against potential attacks on the application. Many have attempted to address the issue of achieving code diversity between different instances of an application in REE, which often does not allow modification of executable code after installation but requires the same execution code for a specific version of the application to be installed regardless of the type and model of the consumer electronic device. Methods, devices, and systems described herein address this issue and are applicable where the robustness of one or more components within the application is critical to its operation and where code diversity provides assurance that it would be difficult to exploit a hack of one instance in other instances of the application.

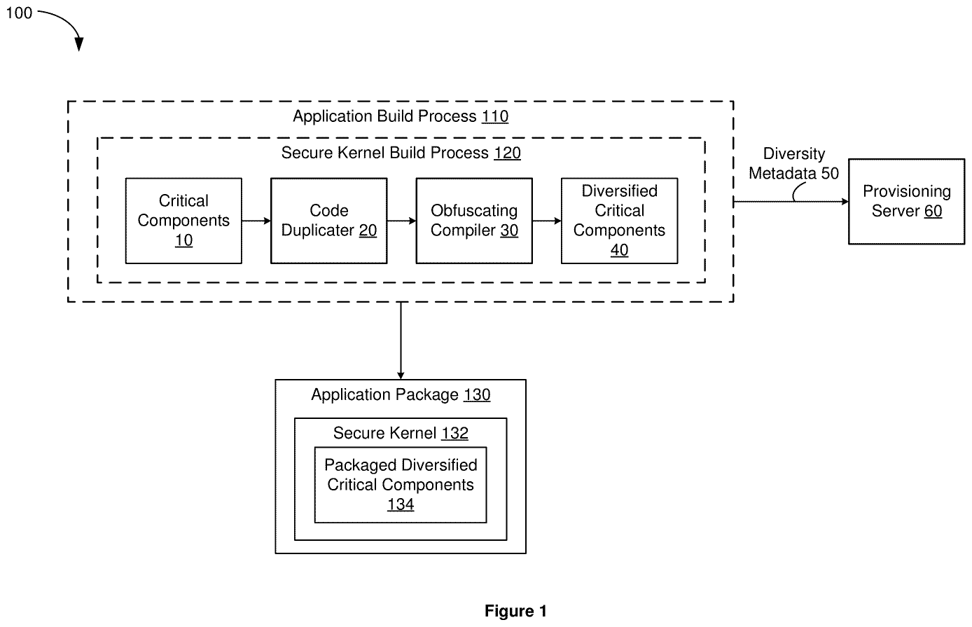

Reference is now made to FIG. 1, which is a block diagram of an exemplary dynamic application packaging and deployment system 100 in accordance with some embodiments. In the exemplary system 100, an application build process 110 includes a secure kernel build process 120. In some embodiments, the application build process 110 generates an application package 130 for deployment on the client side and obtains diversity metadata 50 while generating the application package 130. In some embodiments, the secure kernel build process 120 generates a secure kernel 132 that is packaged with the application package 130.

In some embodiments, the secure kernel 132 is integrated into the application package 130 and controls the execution of packaged diversified critical components 134 on the client side. In some embodiments, as will be described in further detail below, to execute the packaged diversified critical components 134 securely, the secure kernel 132 uses secure communication with a provisioning server 60 to obtain a critical components manifest and securely executes the packaged diversified critical components 134 according to the critical components manifest.

In some embodiments, during the application build process 110, critical components 10 are identified and a source code duplicator 20 duplicates code associated with the critical components 10. Since the method of achieving application diversity relies on code duplication, and code duplication increases the size of the application, it may not be practical to apply the method widely within the application. Because the purpose of diversity is to improve the security of the application, limiting the scope of diversity and duplication to the critical components, which are critical to the operation of the application, and not duplicating non-critical components saves storage and improves efficiency of the application build process 110. In some embodiments, the critical components 10 include functions that do not have calls to the operating system (including I/O) and/or dynamic libraries, as such calls may be traced or hooked. In some embodiments, the critical components 10 provide security services on which the application depends. Examples include cryptographic functions and identity and key management functions. In some embodiments, the critical components 10 are non-functional and intended to confuse reverse engineering without affecting the execution of the application. Thus, the critical components 10 being identified during the application build process 110 can be source code, binary code, functions, modules, libraries, APIs, and/or packages, among others.

In the case where the critical components 10 include source code, a prerequisite for duplication is that the source code of the critical components 10 is organized into modules, where each module is a collection of functions and associated static data that work together to perform a cohesive service. For compilation, each module is organized into a source file that serves as an input to the compilation process. As duplication increases the size of the application, the source code duplicator 20 duplicates source modules that include the critical components 10 and packages the duplicated source modules into the application programming interface (API) implementation of the critical components 10.

In some embodiments, the source code duplicator 20 uses a script to manipulate the symbolic names of functions and variables within a module. For source languages that support preprocessing, the source code duplicator 20 uses the pre-processor for the code duplication in accordance with various embodiments. In both cases, the symbolic names within a duplicated module are modified to be unique within the API implementation of the critical components. For instance, for a source module with global functions, local variables, and local functions, the source code duplicator 20 renames global variables using preprocessor macros within the header file. Regardless of the complexity of the modules, the application build process 110 identifies the critical components within the modules and duplicates the module implementations that are critical to the security of the API. The output from the source code duplicator 20 includes duplicated code that would be invoked through a duplicated API in accordance with various embodiments.

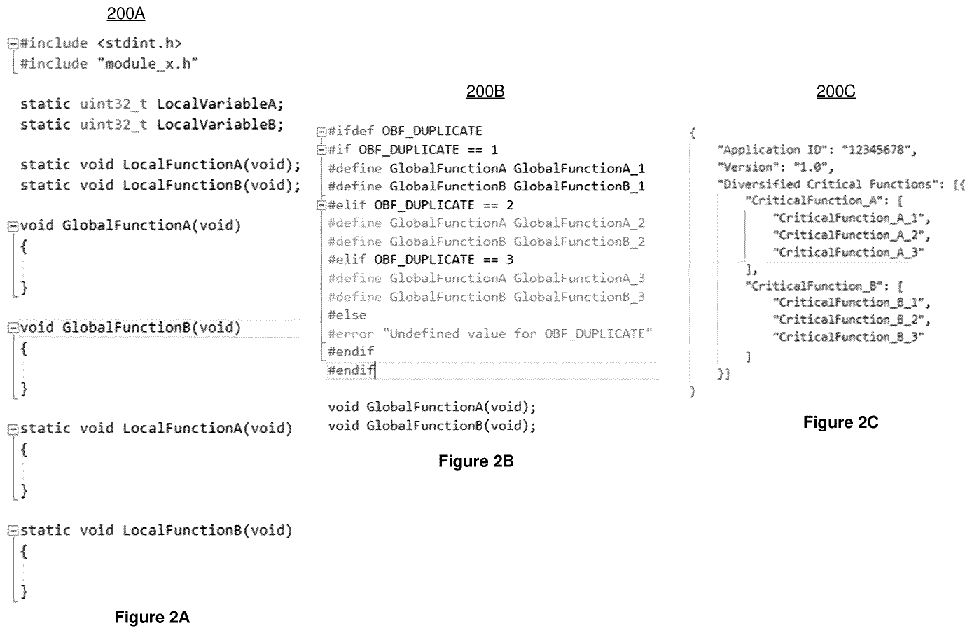

FIGS. 2A-2C illustrate an exemplary module implementation 200A, a corresponding header file 200B, and exemplary corresponding diversity metadata 200C. As shown in FIGS. 2A and 2B, after identifying GlobalFunctionA and GlobalFunctionB in the exemplary module 200A as critical components, the exemplary header file 200B includes preprocessor macros for three duplications of each of GlobalFunctionA and GlobalFunctionB, e.g., duplicating GlobalFunctionA into GlobalFunctionA_1, GlobalFunctionA_2, and GlobalFunctionA_3 and duplicating GlobalFunctionB into GlobalFunctionB_1, GlobalFunctionB_2, and GlobalFunctionB_3. The manipulation of symbolic names of functions and variables within a module by the source code duplicator 20, as shown in FIG. 2A, can be applied to more complex modules and to module implementations that are organized into multiple modules.

In addition to manipulating the module 200A and the header file 200B, the application build process 110 (FIG. 1) also records the diversity metadata 50 (FIG. 1), which describe the diversified critical components 40 (FIG. 1). The exemplary diversity metadata, in the form of a JavaScript Object Notation (JSON) object as shown in FIG. 2C, describe critical components CriticalFunction_A (e.g., GlobalFunctionA) and CriticalFunction_B (e.g., GlobalFunctionB), which have been duplicated as shown in FIG. 2A and diversified as shown in FIG. 2B during the application build process 110 (FIG. 1) for a published application version, e.g., an application with Application ID 12345678 and Version 1.0. Accordingly, the exemplary diversity metadata 200C describe multiple diversified versions of critical components for version 1.0 of the application 12345678, including CriticalFunction_A_1, CriticalFunction_A_2, CriticalFunction_A_3, CriticalFunction_B_1, CriticalFunction_B_2, CriticalFunction_B_3.

Referring back to FIG. 1, in some embodiments, the diversity metadata 50 are generated by the application build process 110 and are used by the provisioning server 60 for the purpose of building a critical components manifest that specifies which one(s) of the diversified critical components 40 would be used in a specific installed application instance on the client side. In some embodiments, the diversity metadata 50 are registered (e.g., by an application developer) with the provisioning server 60 and stored for a specific application version. The diversity metadata 50 can be in machine-readable form or human-readable form, such as the example shown in FIG. 2C.

Continuing with FIG. 1, in some embodiments, the application build process 110 also integrates an obfuscating compiler 30 for obfuscating the duplicated code from the source code duplicator 20 and creating diversified critical components 40. In some embodiments, the diversification of the critical components is achieved through low-level obfuscation transformations that are performed at the stage of compilation rather than high-level transformations, such as modifications to the code itself. While obfuscation makes it harder for an attacker to reverse the application and understand how it works, the obfuscating compiler 30 aims to provide diversity to the critical components 10 so that knowledge gained from one obfuscated variant of a function within the critical components 10 is not useful in applying an exploit to another variant.

In some embodiments, the obfuscating compiler 30 includes a randomized program that transforms modules, e.g., modules that include one or more functions, and optionally static data, and produces functionally equivalent application package(s), which are more difficult to understand and analyze than the original application. In some embodiments, the obfuscating compiler 30 uses multiple state of the art code and data transformations. Examples of code transformations include instruction substitution, dead code insertion, using opaque predicates, merging and splitting functions, control flow flattening, function argument randomization, and re-ordering instructions, etc. As used herein, an “opaque predicate” refers to complex or difficult to understand programs that are evaluated to one possible outcome. It is often applied in code obfuscation to make code more difficult to understand. Examples of data transformations include constant data transformations, array transformations, and splitting or merging variables, among others. The obfuscated assembly code (or obfuscated compiled code and/or obfuscated bytecode) produced by an obfuscating compiler is expected by design to be significantly different on each run of the obfuscating compiler 30, thus ensuring that the obfuscation is independent of the source changes between versions. In some embodiments, the obfuscating compiler 30 selects from various obfuscating methods. Additionally, the obfuscating compiler 30 uses the degree of code transformation in the diversified critical components 40, as compared to the original code in the critical components 10, to select the more effective diversification method in accordance with some embodiments.

In addition, the randomness in obfuscation ensures that the obfuscation is significantly different each time the obfuscating compiler 30 runs. In some embodiments, the obfuscating compiler 30 uses a source of randomness for obfuscating transformations. For example, the obfuscating compiler 30 can utilize opaque predicates, where the value is known to the obfuscating compiler 30 at obfuscation time but would be difficult for an attacker to figure out afterwards. More generally, the obfuscating compiler 30 can perform the transformation by utilizing a random seed to determine which functions or blocks to change and/or how they would be changed. In some embodiments, the obfuscating compiler 30 randomly selects a seed for obfuscation to ensure that the output is different for each obfuscation pass.

As a result of the obfuscation by the obfuscating compiler 30, an application is packaged to include diversified critical components 40 with significantly different code for the same functionality, such that the number of duplicated critical components from the source code duplicator 20 determines the overall level of application diversity. Accordingly, the application package 130, which would be downloaded, installed, and executed on a client device, has multiple, different, and obfuscated instances of the critical components 10, e.g., the packaged diversified critical components 134 corresponding to multiple, different, and obfuscated instances of the critical components 10.

As shown in FIG. 1, the application build process 110 includes the secure kernel build process 120. In some embodiments, the secure kernel 132 generated through the secure kernel build process 120 is integrated into the application package 130, thus utilizing the underlying platform security features. In some embodiments, the secure kernel 132 provides critical functions to the application, such as authentication, encryption, verification, integrity check, and secure communication with the provisioning server 60. Further, the secure kernel 132 facilitates provisioning of a critical components manifest from the provisioning server 60, verifies the integrity of the critical components manifest (e.g., by validating a server private signature), securely stores the critical components manifest, and re-provisions the critical components manifest according to policy (e.g., upon the expiration time or renewal time).

As will be described in further detail below, the secure kernel 132 also controls which one(s) of the packaged diversified critical components 134 would be executed for a specific application instance according to the instructions provided in the provisioned critical components manifest. Components for facilitating the above are identified as part of the critical components during the application build process 110, duplicated by the code duplicator 20, and diversified by the obfuscating compiler 30. As a result, the secure kernel 132 incorporates controller code to call the packaged diversified critical components 134 to ensure that functions for security enhancement are linked to the application. In some embodiments, the decision of which critical components 10 to duplicate is synchronized with the development of the secure kernel 132 such that the secure kernel 132 is built with the diversified critical components 40 and such that each of the diversified critical components 40 can be invoked by the secure kernel 132. In some embodiments, the secure kernel 132 is protected using techniques such as symbolic stripping, code and data obfuscation, anti-de-obfuscation protection, tampering protection, reversing hardening, and anti-debugging, among others.

It should be noted that the diversification and obfuscation by the obfuscating compiler 30 are applicable to an application whose source code is compiled into machine code or bytecode as well as to an application that links native code or bytecode. As such, a compiler toolchain supporting the obfuscating compiler 30 can be programming language and/or target specific, or programming language and/or target agonistic, e.g., compiler toolchains such as low level virtual machine (LLVM) or GNU compiler collection (GCC) that can be used with a wide range of programming languages and have backends for many instruction set architectures.

It should also be noted that one or more elements, units, and/or modules of the components illustrated in FIG. 1 may be combined, distributed, and/or re-arranged. For example, the code duplicator 20 can be part of the obfuscating compiler 30 or as a separate element, e.g., on a separate computing device and/or system. As such, the exemplary system 100 can include more, fewer, and/or different elements than shown in FIG. 1. Each of the elements in the exemplary system 100 can include appropriate hardware, software, and/or firmware to perform the operations attributed to the elements herein. Operation(s) attributed to an element in the exemplary system 100 herein should not be considered binding, and in some embodiments, other element(s) in the exemplary system 100 may additionally or alternatively perform such operation(s).

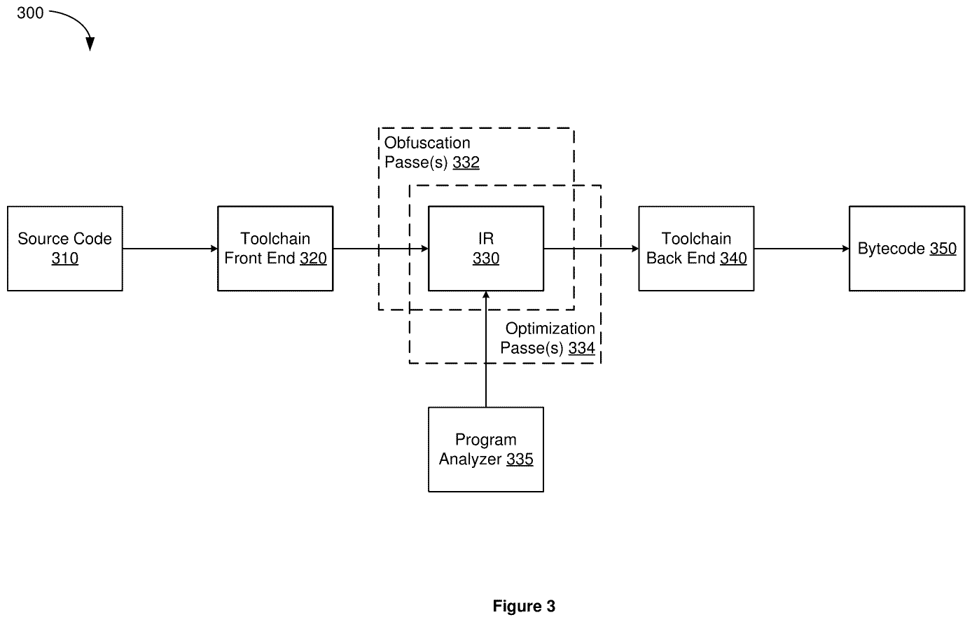

FIG. 3 is an exemplary compiler toolchain 300 supporting the obfuscating compiler 30 (FIG. 1) in accordance with various embodiments. In FIG. 3, a toolchain front end 320 obtains source code 310 and converts the source code 310 into an intermediate representation (IR) 330. An IR typically includes the data structure or code used internally by a compiler or virtual machine to represent the source code 310. An IR 330 is designed to be conducive to further processing, such as optimization and translation. In FIG. 3, a toolchain back end 340 converts the IR 330 into bytecode 350. In some embodiments, one or more obfuscation passes 332 performed by the obfuscating compiler 30 (FIG. 1) operate on the IR 330 such that the obfuscation would be both source language agnostic (e.g., agnostic of the programming language of the source code 310 received by the toolchain front end 320) and backend agnostic (e.g., agnostic of the bytecode 350 outputted by the toolchain back end 340). The bytecode 350 typically is a form of instruction set designed for efficient execution. Unlike the human-readable source code 310, the bytecode 350 typically includes compact numeric codes, constants, and references (e.g., numeric addresses) that encode the result of compiler parsing and semantic analysis of things like type, scope, and nesting depths of program objects.

In some embodiments, the compiler toolchain 300 includes a program analyzer 335 that analyzes the code size of the IR and the performance of the compiler toolchain 300. In some embodiments, the compiler toolchain 300 also supports one or more optimization passes 334 based on the analysis by the program analyzer 335. In some embodiments, the one or more optimization passes 334 act on and transform the IR 330 to meet code size targets and/or speed performance targets. As described above, code diversification increases code size. Some optimization passes 334 may counteract obfuscation passes 332. For example, a respective optimization pass 334 that simplifies the control flow graph for a function is likely to counteract with a respective obfuscation pass 332 that increases control flow complexity. To address this, the obfuscating compiler 30 (FIG. 1) described herein is designed to be resilient to compiler optimizations. Conversely, consideration is given to performing optimization both before and after obfuscation in order to balance code size and performance goals.

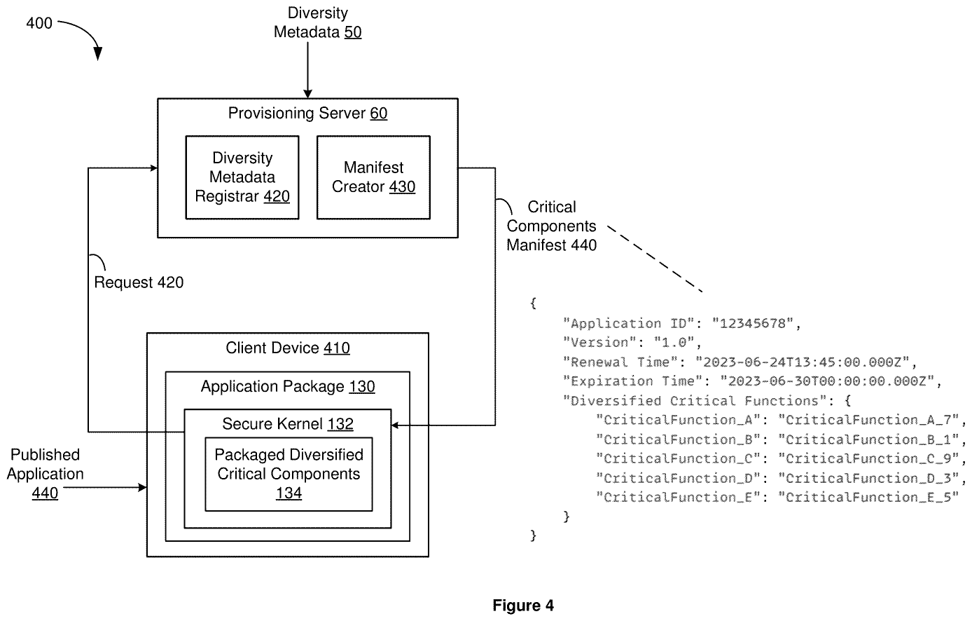

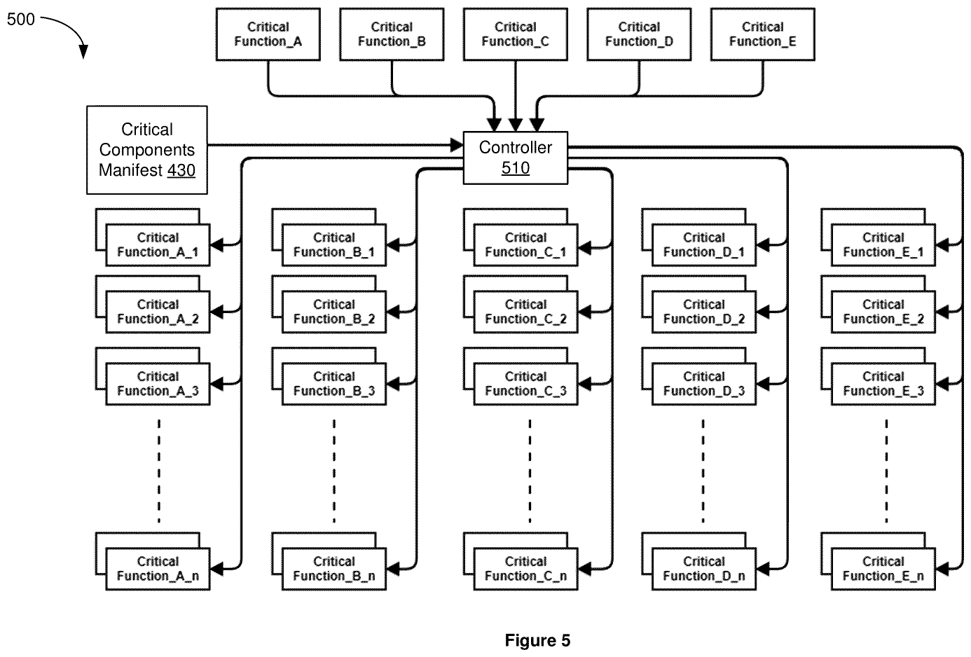

FIG. 4 is a diagram 400 illustrating the deployment of the packaged diversified critical components on a client device 410 in accordance with various embodiments. In some embodiments, the client device 410 includes a TV, a set-top-box (STB), a mobile device, a consumer electronic device, a console, and/or a computing device with a download controller. In preparation for publishing a version of an application, an application developer typically builds the application from an application source code repository using an application build process based on a build toolchain applicable to the client device type and/or model. The application developer then publishes the application to a managed application store or a service provider repository, e.g., the application package 130 as a downloadable file. Publishing typically involves a review process to verify that the application conforms to technical requirements, such as preventing the download and execution of dynamic code. The user of the client device 410 then downloads and installs the application package 130.

In such an environment, the program code of the installed application package 130 is required to be identical for any installation of the same version of the same application. Using the code duplicator 20 (FIG. 1) and the obfuscating compiler 30 (FIG. 1) as described above, the application package 130 is the same for different client devices 140 installing the same version of the same application. Therefore, when the application developer publishes the application package 130, the packaged diversified critical components 134 can pass the publishing review and are downloadable to the client device 140 for dynamic execution, which further improves the security of running critical components on open platforms.

In some embodiments, the provisioning server 60 is a server hosted on an internet-based service and implements security practices for authentication, access controls, replay attack protection, end-to-end integrity protection, end-to-end encryption, and/or denial-of-service protection, etc. In some embodiments, the provisioning server 60 supports multiple service interfaces. One service interface, a diversity metadata registrar 420 is used for registering the diversity metadata 50 for a published application version. For example, an application developer provides the diversity metadata as shown in FIG. 2C to the diversity metadata registrar 420 to register for the published application with ID 12345678 and version 1.0. In addition to registering, the diversity metadata registrar 420 can also be used to deregister an application. In some embodiments, after verifying the authenticity of a registration request for the diversity metadata 50, the provisioning server 60 persistently stores the diversity metadata 50 for the application version such that the diversity metadata 50 for multiple versions of the application can be stored simultaneously, e.g., concurrently storing in the non-transitory memory of the provisioning server 60 the diversity metadata 50 for multiple versions of the published application.

In some embodiments, another service interface, a manifest creator 430 is used for provisioning a critical components manifest 440 on-demand for an installed application instance. After installation of the application package 130 on the client device 410, the secure kernel 132 within the application package 130 communicates with the provisioning server 60 via a request 420 to provision the application package 130. In some embodiments, the request 420 identifies the application package 130 installed on the client device 410 and attributes of the application package 130, such as the application ID, the version, timestamp(s), etc. The identification of the application version allows the scope of code diversity vary in different versions.

In response to receiving the request 420 and upon authenticating the request 420, the manifest creator 430 accesses the diversity metadata 50 registered for the application version and selects from the diversity metadata 50 one of the duplicates for each critical component. Various methods of selection can be used, including random selection. The critical components manifest 440 thus has individualized instructions on which one(s) of the packaged diversified critical components would be called in this application instance for performing a specific critical function. In some embodiments, the provisioning request 420 is made over a secure channel upon successful identification and authentication of the client device 410 by the provisioning server 60 to ensure the integrity and privacy of data communicated over the channel. In some embodiments, the secure kernel 132 periodically requests a renewal of the critical components manifest 440 from the provisioning server 60.

The critical components manifest 440 can take any form suitable for conveying the mapping, e.g., a JSON object as shown in FIG. 4 or a YAML file. In the example shown in FIG. 4, the critical components manifest file 440 maps five security service APIs associated with the duplicated components selected for the application instance, e.g., CriticalFunction_A_7, CriticalFunction_B_1, CriticalFunction_C_9, CriticalFunction_D_3, and CriticalFunction_E_5. In some embodiments, the critical components manifest 440 also includes usage rules for determining the life cycle of the manifest 430 and the renewal of the critical components manifest 440, e.g., renewal time of 2023-06-24T13:45:00.000Z and expiration time of 2023-06-30T00:00:00.000Z as shown in FIG. 4. In some embodiments, the provisioning server 60 provides a secure and aligned time base to ensure that the notion of time for the secure kernel 132 aligns with the provisioning server 60.

In some embodiments, the critical components manifest 440 is accompanied by a signature that can be used to verify its authenticity and integrity, such as the provisioning server 60 signing the critical components manifest 440 using a private key it owns. In some embodiments, upon receiving the critical components manifest 440, the client device 410 encrypts it to ensure confidentiality. As will be described in further detail below, the critical components manifest 440 supports the execution of a sequence of critical components combined with non-functional critical components designed to confuse reverse engineering without affecting the execution of the intended function of the critical components.

FIG. 5 is a diagram 500 illustrating a secure kernel controller 510 for dynamic application execution on client devices in accordance with some embodiments. In some embodiments, the secure kernel controller 510 executes the secure kernel 132 (FIGS. 1 and 4). As such, the secure kernel controller 510 is also referred to as the controller 510 or used interchangeably to the secure kernel.

As described above, in some embodiments, the secure kernel 132 (FIGS. 1 and 4) is integrated into the application package 130 (FIGS. 1 and 4), leverages underlying platform security features, and applies the critical components manifest 440 to select a critical function to run. In some embodiments, to counter the risk of a provisioning request to the provisioning server 60 (FIGS. 1 and 4) being blocked or bypassed - thereby forcing the application instance to execute specific functions - the secure kernel 132 (FIGS. 1 and 4) implements a state ensuring that any critical functions do not operate before the provisioning process is completed. In some embodiments, the secure kernel 132 (FIGS. 1 and 4) also ensures that critical components do not operate when the currently provisioned critical components manifest 440 has expired.

For example, in FIG. 5, the controller 510 prevents the execution of any of the critical functions without first obtaining the critical components manifest 440. Further, using the exemplary critical components manifest 440 shown in FIG. 4, in some embodiments, the controller 510 prevents the execution of any of the critical functions after the expiration time of 2023-06-30T00:00:00.000Z. Additionally, when applying the exemplary critical components manifest 440 shown in FIG. 4, the secure controller 510 selects CriticalFunction_A_7 for execution from among CriticalFunction_A_1, CriticalFunction_A_2, CriticalFunction_A_3, . . . , CriticalFunction_A_n, when a request for CriticalFunctionA is made. Likewise, when applying the exemplary critical components manifest 440 shown in FIG. 4, the secure controller 510 selects CriticalFunction_B_1 for execution from among CriticalFunction_B_1, CriticalFunction_B_2, CriticalFunction_B_3, . . . , CriticalFunction_B_n, when a request for CriticalFunctionB is made.

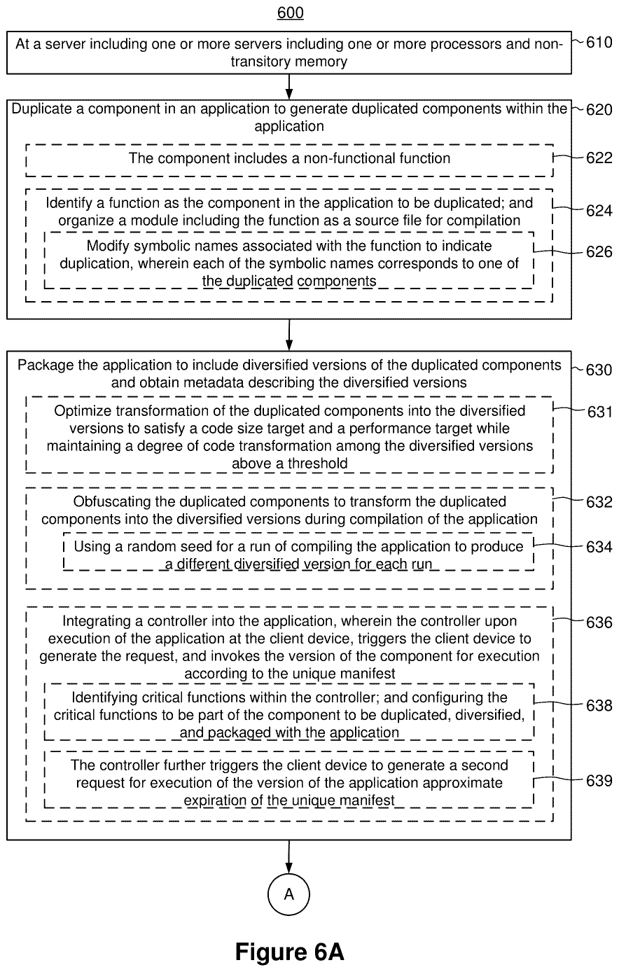

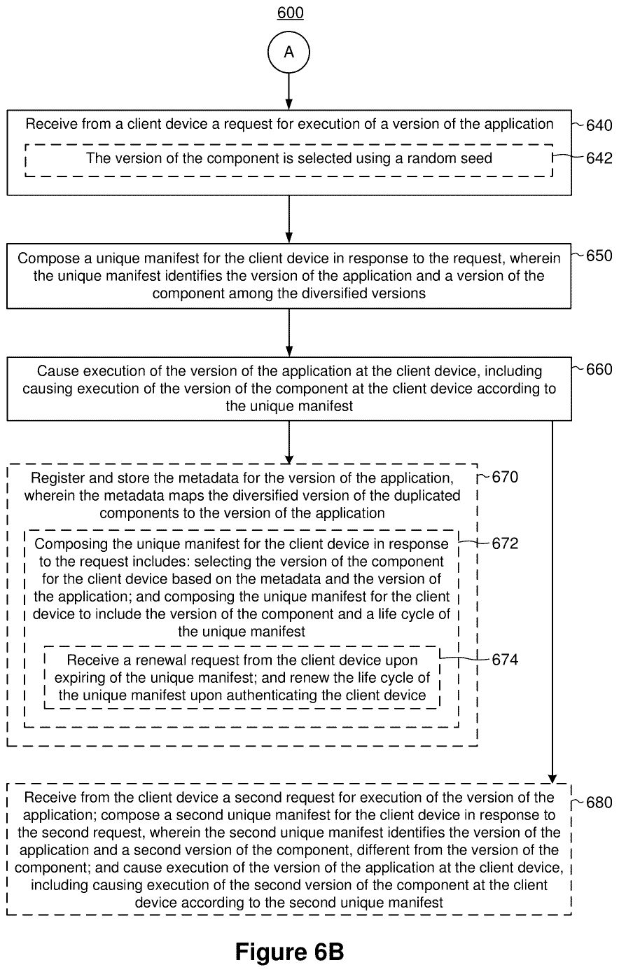

FIGS. 6A and 6B represent a flowchart illustrating a method 600 for dynamic application execution in accordance with some embodiments. In some embodiments, as represented by block 610 in FIG. 6A, the method 600 is performed at one or more servers that include one or more processors and non-transitory memory, e.g., one or more servers performing the application build process 110 (FIG. 1) and/or the provisioning server 60 (FIGS. 1 and 4). In some embodiments, the one or more servers are located in a core network, backend, distributed between a core network and an edge device, or on an edge device.

As represented by block 620, the method 600 includes duplicating a component in an application to generate duplicated components within the application. In some embodiments, as represented by block 622, the component includes a non-functional function, e.g., a NULL operation that is non-function to confuse reverse engineering without affecting the execution of the application. In some embodiments, as represented by block 624, duplicating the component in the application to generate duplicated components includes: (a) identifying a function as the component in the application to be duplicated; and (b) organizing a module including the function as a source file for compilation. For example, in FIG. 2A, GlobalFunctionA and GlobalFunctionB are identified as critical functions to be duplicated, and a module including such functions is organized as a source file for compilation. In such embodiments, as represented by block 626, the method 600 in accordance with some embodiments further includes modifying symbolic names associated with the function to indicate duplication, wherein each of the symbolic names corresponds to one of the duplicated components. For example, FIG. 2B shows the manipulation of symbolic names of GlobalFunctionA and GlobalFunctionB by defining GlobalFunctionA_1, GlobalFunctionA_2, GlobalFunctionA_3, GlobalFunctionB_1, GlobalFunctionB_2, and GlobalFunctionB_3, e.g., using a macro to modify names such as GlobalFunctionA and GlobalFunctionB, and indicating these names as duplications of GlobalFunctionA and GlobalFunctionB. By identifying GlobalFunctionA and GlobalFunctionB as critical functions and duplicating these parts of the API implementation, duplicate code would be invoked through a duplicated API.

As represented by block 630, the method 600 further includes packaging the application to include diversified versions of the duplicated components and obtaining metadata describing the diversified versions. In some embodiments, as represented by block 631, packaging the application to include the diversified versions of the duplicated components includes optimizing transformation of the duplicated components into the diversified versions to satisfy a code size target and a performance target while maintaining a degree of code transformation among the diversified versions above a threshold.

For example, in FIG. 1, the application build process 110 produces the application package 130 by packaging the duplicating components from the code duplicated 20 into the diversified critical components, which are diversified versions of the duplicated components. Further, as shown in FIG. 1, when packaging the application, the obfuscating compiler 30 records the diversified metadata 50 and sends to the provisioning server 60 for registration. The exemplary diversified metadata 50 as shown in FIG. 2C describe the diversified versions, such as CriticalFunction_A_1, CriticalFunction_A_2, and CriticalFunction_A_3, etc. In another example, in FIG. 3, the obfuscating compiler 30 (FIG. 1) executes the obfuscation passes 332 as well as optimization passes 334. The obfuscation passes 332 ensures that the degree of code transformation among the diversified versions such as CriticalFunction_A_1, CriticalFunction_A_2, and CriticalFunction_A_3 references in the diversity metadata 200C (FIG. 2C) is greater than a threshold. In other words, each of the diversified versions generated during a respective run of the obfuscation passes 332 is significantly different from others, e.g., the difference between CriticalFunction_A_1 and CriticalFunction_A_2 is above a threshold. At the same time, consideration is given to performing the optimization passes 334 (FIG. 3) both before and after the obfuscation in order to achieve code size and performance targets, e.g., the performance of the obfuscation passes 332 (FIG. 3) satisfies a performance target and the size of the diversified versions satisfies a code size target.

In some embodiments, as represented by block 632, packaging the application to include the diversified versions of the duplicated components includes obfuscating the duplicated components to transform the duplicated components into the diversified versions during compilation of the application. As such, the diversification of the critical functions is achieved through low-level obfuscation transformations performed at the stage of compilation rather than high-level transformations, e.g., by the obfuscating compiler 30 (FIG. 1). In such embodiments, as represented by block 634, obfuscating the duplicated components includes using a random seed for a run of compiling the application to produce a different diversified version for each run. In other words, the obfuscated code produced by the obfuscating compiler 30 (FIG. 1) is expected by design to be significantly different on each run to ensure that the obfuscation is independent of the source changes between versions, e.g., the degree of code transformation by the obfuscating compiler 30 (FIG. 1) between two different obfuscation passes 332 (FIG. 3) is greater than a threshold.

In some embodiments, as represented by block 636, packaging the application to include the diversified versions of the duplicated components includes integrating a controller into the application, wherein the controller upon execution of the application at the client device, triggers the client device to generate the request, and invokes the version of the component for execution according to the unique manifest. In such embodiments, as represented by block 638, integrating the controller into the application includes: (a) identifying critical functions within the controller; and (b) configuring the critical functions to be part of the component to be duplicated, diversified, and packaged with the application in accordance with some embodiments. Also in such embodiments, as represented by block 639, the controller further triggers the client device to generate a second request for execution of the version of the application approximate expiration of the unique manifest in accordance with some embodiments.

For example, in FIG. 1, the application build process 110 includes a secure kernel build process 120, which generates and integrates the secure kernel 132 into the application package 130. Because the secure kernel build process 120 is part of the application build process 110 and identifies the secure kernel 132 as part of the critical components 10, the code duplicator 20 duplicates the source code of the secure kernel 132 and the obfuscating compiler 30 creates the secure kernel 132 as part of the diversified critical components 40 for enhanced security. As shown in FIGS. 4 and 5, upon installing the application package 130 (e.g., by downloading the published application 440), the secure kernel 132 integrated into the application package 130 is deployed on the client device 410 and runs as the controller 510. The secure kernel 132 thus incorporates controller code of the controller 510 whose purpose is to call each diversified critical component to ensure that the security functions are linked into the application.

Further as shown in FIGS. 4 and 5, the controller 510 controls the execution of the application at the client device 410 by triggering the client device 410 to send the request 420 to the provisioning server 60, obtains the critical components manifest 440, selects a version from the diversified versions according to the critical components manifest 440, and invokes the selected version of the component for execution, e.g., selecting CriticalFunction_A_7 from CriticalFunction_A_1, CriticalFunction_A_2, CriticalFunction_A_3, . . . , CriticalFunction_A_n for execution. In FIG. 4, the exemplary critical components manifest 440 includes a renewal time and an expiration time. To further enhance the security, though not shown in FIG. 5, the controller 510 re-provisions the critical components manifest 440 according to policy. For example, when the renewal time and/or the expiration time specified in the critical components manifest 440 are within a threshold from the current time, the controller 510 (FIG. 5) triggers the client device 410 (FIG. 4) to generate another request to the provisioning server 60 for execution of CriticalFunction_A_7.

Turning to FIG. 6B, as represented by block 640, the method 600 also includes receiving from a client device a request for execution of a version of the application. In some embodiments, as represented by block 642, the version of the component is selected using a random seed. As represented by block 650, the method 600 additionally includes composing a unique manifest for the client device in response to the request, wherein the unique manifest identifies the version of the application and a version of the component among the diversified versions. As represented by block 660, the method 600 further includes causing execution of the version of the application at the client device, including causing execution of the version of the component at the client device according to the unique manifest. For example, in FIG. 4, upon receiving the request 420 from the client device 410, the manifest creator 430 of the provisioning server 60 uses a random seed to select CriticalFunction_A_7 among CriticalFunction_A_1, CriticalFunction_A_2, CriticalFunction_A_3, . . . , CriticalFunction_A_n in the diversity metadata and specifies CriticalFunction_A_7 in the critical components manifest 440. At the time of dynamic execution, as shown in FIG. 5, the controller 510 executes CriticalFunction_A_7 according to the critical components manifest 440.

In some embodiments, as represented by block 670, the method 600 further includes registering and storing the metadata for the version of the application, wherein the metadata maps the diversified version of the duplicated components to the version of the application. In such embodiments, as represented by block 672, composing the unique manifest for the client device in response to the request includes: (a) selecting the version of the component for the client device based on the metadata and the version of the application; and (b) composing the unique manifest for the client device to include the version of the component and a life cycle of the unique manifest in accordance with some embodiments. Further in such embodiments, as represented by block 674, the method 600 includes: (a) receiving a renewal request from the client device upon expiring of the unique manifest; and (b) renewing the life cycle of the unique manifest upon authenticating the client device.

For example, in FIG. 4, the diversity metadata registrar 420, upon verifying the authenticity of a registration request for diversity metadata, persistently stores the diversity metadata for the application version 1.0. By storing for each version of the application 12345678, the diversity metadata for multiple versions of the application can be stored simultaneously. Also as shown in FIG. 4, the manifest creator 430 constructs the critical components manifest 440 that maps each critical function with the diversified critical function selected for the application instance, e.g., version 1.0 of application 12345678, and includes usage rules for determining the life cycle of the manifest and when it is required to be renewed, e.g., by specifying the renewal time and/or expiration time. In some embodiments, the provisioning server provides a secure and aligned time base to ensure that the secure kernel's notion of time is aligned with the provisioning server, and upon the current time on the client device approaching the renewal time and/or expiration time, the client device sends a renewal request to the provisioning server.

In some embodiments, as represented by block 690, the method 600 further includes: (a) receiving from the client device a second request for execution of the version of the application; (b) composing a second unique manifest for the client device in response to the second request, wherein the second unique manifest identifies the version of the application and a second version of the component, different from the version of the component; and (c) causing execution of the version of the application at the client device, including causing execution of the second version of the component at the client device according to the second unique manifest. For example, in FIG. 4, when the client device 410 sends another request for execution of version 1.0 of application 12345678, upon authenticating the request, the provisioning server 60 generates a different critical components manifest 440, which specifies a list of different diversified critical functions to be executed on the client device 410, e.g., specifying CriticalFunction_A_3 instead of CriticalFuction_A_7, etc.

Using the dynamic application execution method described herein, even if one version of a respective critical component is compromised on the same client device, a different version of the critical component would not be affected, e.g., compromising CriticalFunction_A_3 would not affect the execution of CriticalFunction_A_7. Likewise, when multiple client devices request the same version of the application, e.g., multiple client devices requesting the execution of version 1.0 of application 12345678, each client device receives a different and unique critical components manifest specifying different versions of critical components to facilitate the dynamic application execution on each client device. As such, even if one client application execution environment is compromised and a version of a critical component is exposed, other versions of the same critical component on other client devices would not be affected.

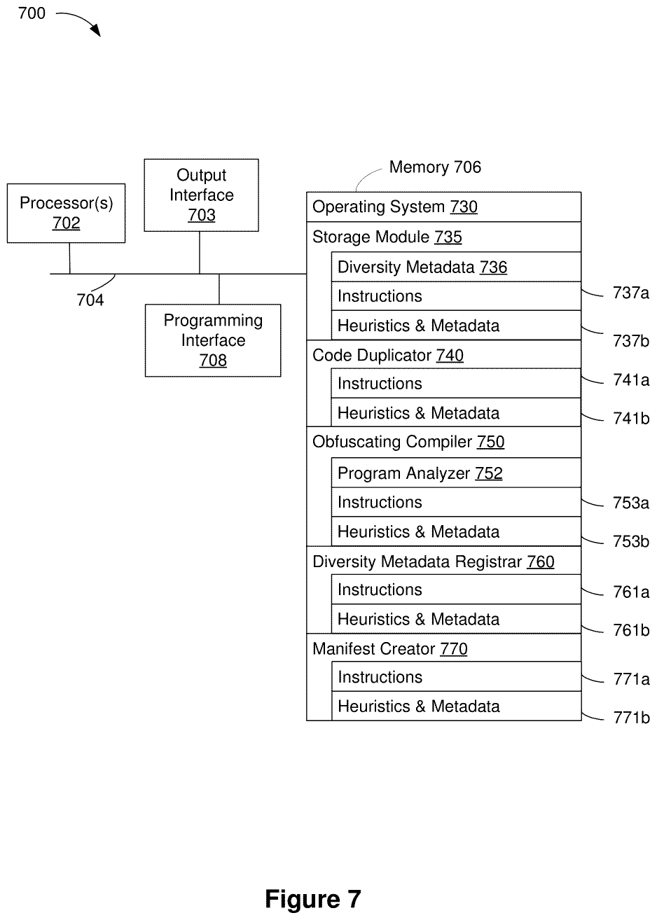

FIG. 7 is a block diagram of a computing device 700 for dynamic application execution in accordance with some embodiments. In some embodiments, the computing device 700 corresponds to the one or more servers running the application build process 110 (FIG. 1) and/or hosting the provisioning server 60 (FIGS. 1 and 4) and performs one or more of the functionalities described above performed by the code duplicator 20, the obfuscating compiler 30, and/or the provisioning server 60 with reference to FIGS. 1 and 3-4. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 700 includes one or more processing units 702 (e.g., CPU(s)/GPU(s)), one or more output interfaces 703 (e.g., one or more network interfaces for connecting with another computing device), a memory 706, a programming interface 708, and one or more communication buses 704 for interconnecting these and various other components.

In some embodiments, the communication buses 704 include circuitry that interconnects and controls communications between system components. The memory 706 includes high-speed random access memory, such as DRAM, SRAM, DDR RAM or other random access solid state memory devices; and, in some embodiments, include non-volatile memory, such as one or more magnetic disk storage devices, optical disk storage devices, flash memory devices, or other non-volatile solid state storage devices. The memory 706 optionally includes one or more storage devices remotely located from the CPU(s) 702. The memory 706 comprises a non-transitory computer readable storage medium. Moreover, in some embodiments, the memory 706 or the non-transitory computer readable storage medium of the memory 706 stores the following programs, modules and data structures, or a subset thereof including an optional operating system 730, a storage module 735, a code duplicator 740, an obfuscating compiler 750, a diversity metadata registrar 760, and a manifest creator 770. In some embodiments, one or more instructions are included in a combination of logic and non-transitory memory. The operating system 730 includes procedures for handling various basic system services and for performing hardware dependent tasks.

In some embodiments, the storage module 735 is configured to store and/or manage data to facilitate dynamic application execution on client devices. In some embodiments, the storage module 735 stores diversity metadata 736, e.g., the diversity metadata 50 (FIGS. 1 and 4) produced from the application build process 110 (FIG. 1), registered with the diversity metadata registrar 420 (FIG. 4), and stored in the non-transitory memory of provisioning server 60 (FIGS. 1 and 4). To that end, the storage module 735 includes a set of instructions 737a and heuristics and metadata 737b.

In some embodiments, the code duplicator 740 (e.g., the code duplicator 20, FIG. 1) is configured to duplicate critical components (e.g., the critical components 10, FIG. 1) and generate duplicated components within an application, e.g., generating GlobalFunctionA_1 and GlobalFunctionA_2 for critical component GlobalFunctionA as shown in FIGS. 2A and 2B. To that end, the code duplicator 740 includes a set of instructions 741a and heuristics and metadata 741b.

In some embodiments, the obfuscating compiler 750 (e.g., the obfuscating compiler 30 in FIG. 1 and/or the compiler for performing the obfuscation passes 332 in FIG. 4) is configured to generate and package diversified versions of the duplicated components from the code duplicator 740 (e.g., generating and packaging the diversified critical components 40 (FIG. 1) as diversified versions of the critical components 10 (Figure)) and record the diversity metadata 50 describing the diversified versions. In some embodiments, for optimization, the obfuscating compiler 750 includes a program analyzer 752 (e.g., the program analyzer 335, FIG. 3) for analyzing the code size of the diversified versions and the performance of the obfuscation. To that end, the obfuscating compiler 750 includes a set of instructions 753a and heuristics and metadata 753b.

In some embodiments, the diversity metadata registrar 760 (e.g., the diversity metadata registrar 420, FIG. 4) receives the diversity metadata 50 (FIG. 1) recorded during the application build process 110 (FIG. 1) and stores the diversity metadata 50 (FIG. 1) such as the example shown in FIG. 2C for each version of the application in the storage module 735. To that end, the diversity metadata registrar 760 includes a set of instructions 761a and heuristics and metadata 761b.

In some embodiments, the manifest creator 770 (e.g., the manifest creator 430, FIG. 4) generates unique manifest in response to client requests based on the diversity metadata 735, e.g., the critical components manifest 440 generated based on the diversity metadata 50 in FIG. 4, and sends the unique manifest to client devices. To that end, the manifest creator 770 includes a set of instructions 771a and heuristics and metadata 771b.

Although the storage module 735, the code duplicator 740, the obfuscating compiler 750, the diversity metadata registrar 760, and the manifest creator 770 are illustrated as residing on a single computing device 700, it should be understood that in other embodiments, any combination of the storage module 735, the code duplicator 740, the obfuscating compiler 750, the diversity metadata registrar 760, and the manifest creator 770 can reside in separate computing devices in various embodiments. For example, in some embodiments, each of the storage module 735, the code duplicator 740, the obfuscating compiler 750, the diversity metadata registrar 760, and the manifest creator 770 resides on a separate computing device.

Moreover, FIG. 7 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 7 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, which changing the meaning of the description, so long as all occurrences of the “first device” are renamed consistently and all occurrences of the “second device” are renamed consistently. The first device and the second device are both devices, but they are not the same device.

The terminology used herein is for the purpose of describing particular embodiments only and is not intended to be limiting of the claims. As used in the description of the embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at one or more servers including one or more processors and non-transitory memory:
duplicating a component in an application to generate duplicated components within the application;
packaging the application to include diversified versions of the duplicated components and obtaining metadata describing the diversified versions;
receiving from a client device a request for execution of a version of the application;
composing a unique manifest for the client device in response to the request, wherein the unique manifest identifies the version of the application and a version of the component among the diversified versions; and
causing execution of the version of the application at the client device, including causing execution of the version of the component at the client device according to the unique manifest.

2. The method of claim 1, wherein the component includes a non-functional function.

3. The method of claim 1, wherein duplicating the component in the application to generate duplicated components includes:
identifying a function as the component in the application to be duplicated; and
organizing a module including the function as a source file for compilation.

4. The method of claim 3, further comprising:
modifying symbolic names associated with the function to indicate duplication, wherein each of the symbolic names corresponds to one of the duplicated components.

5. The method of claim 1, wherein packaging the application to include the diversified versions of the duplicated components includes:
optimizing transformation of the duplicated components into the diversified versions to satisfy a code size target and a performance target while maintaining a degree of code transformation among the diversified versions above a threshold.

6. The method of claim 1, wherein packaging the application to include the diversified versions of the duplicated components includes:
obfuscating the duplicated components to transform the duplicated components into the diversified versions during compilation of the application.

7. The method of claim 6, wherein obfuscating the duplicated components includes:
using a random seed for a run of compiling the application to produce a different diversified version for each run.

8. The method of claim 1, wherein packaging the application to include the diversified versions of the duplicated components includes:
integrating a controller into the application, wherein the controller upon execution of the application at the client device, triggers the client device to generate the request, and invokes the version of the component for execution according to the unique manifest.

9. The method of claim 8, wherein integrating the controller into the application includes:
identifying critical functions within the controller; and
configuring the critical functions to be part of the component to be duplicated, diversified, and packaged with the application.

10. The method of claim 8, wherein the controller further triggers the client device to generate a second request for execution of the version of the application approximate expiration of the unique manifest.

11. The method of claim 1, wherein the version of the component is selected using a random seed.

12. The method of claim 1, further comprising:
registering and storing the metadata for the version of the application, wherein the metadata maps the diversified version of the duplicated components to the version of the application.

13. The method of claim 12, wherein composing the unique manifest for the client device in response to the request includes:
selecting the version of the component for the client device based on the metadata and the version of the application; and
composing the unique manifest for the client device to include the version of the component and a life cycle of the unique manifest.

14. The method of claim 13, further comprising:
receiving a renewal request from the client device upon expiring of the unique manifest; and
renewing the life cycle of the unique manifest upon authenticating the client device.

15. The method of claim 1, further comprising:
receiving from the client device a second request for execution of the version of the application;
composing a second unique manifest for the client device in response to the second request, wherein the second unique manifest identifies the version of the application and a second version of the component, different from the version of the component; and
causing execution of the version of the application at the client device, including causing execution of the second version of the component at the client device according to the second unique manifest.

16. A non-transitory memory storing one or more programs, which, when executed by one or more servers with one or more processors, cause the one or more servers to:
duplicate a component in an application to generate duplicated components within the application;
package the application to include diversified versions of the duplicated components and obtain metadata describing the diversified versions;
receive from a client device a request for execution of a version of the application;
compose a unique manifest for the client device in response to the request, wherein the unique manifest identifies the version of the application and a version of the component among the diversified versions; and
cause execution of the version of the application at the client device, including causing execution of the version of the component at the client device according to the unique manifest.

17. The non-transitory memory of claim 17, wherein the component includes a non-functional function.

18. The non-transitory memory of claim 17, wherein duplicating the component in the application to generate duplicated components includes:
identifying a function as the component in the application to be duplicated; and
organizing a module including the function as a source file for compilation.

19. The non-transitory memory of claim 18, wherein the one or more programs, which, when executed by the one or more servers, further cause the one or more servers to:
modify symbolic names associated with the function to indicate duplication, wherein each of the symbolic names corresponds to one of the duplicated components.

20. A server comprising:
one or more processors;
a non-transitory memory;
a network interface; and
one or more programs, stored in the non-transitory memory, which, when executed by the one or more processors, cause the server to:
duplicate a component in an application to generate duplicated components within the application;
package the application to include diversified versions of the duplicated components and obtain metadata describing the diversified versions;
receive from a client device a request for execution of a version of the application;
compose a unique manifest for the client device in response to the request, wherein the unique manifest identifies the version of the application and a version of the component among the diversified versions; and
cause execution of the version of the application at the client device, including causing execution of the version of the component at the client device according to the unique manifest.
